(19) United States
(12) Patent Application Publication
(10) Pub. No.: US 2010/0166921 A1
(43) Pub. Date: Jul. 1, 2010

(54) COATING

(75) Inventor: Fernando Qvyjt, Memphis, TN (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a UNILEVER, Englewood Cliffs, NJ (US)

(21) Appl. No.: 12/345,011

(22) Filed: Dec. 29, 2008

(51) Int. Cl. A23G 1/54; A23D 7/00

(52) U.S. Cl. 426/93; 426/89

(57) ABSTRACT

A fat continuous coating which is suitable for coating nutrition bars and other products, especially foods products, which include less saturated fat. The coating includes a lipid base having a phytosterol and/or phytostanol structurant, and up to 28 wt % or less saturated fatty acid moieties. The phytosterol or phytostanol serves to provide sufficient structure to the coating to obviate the need for the higher levels of saturated fats which such ingredients tend ordinarily to contain. The coating will advantageously include numerous other ingredients typically found in coatings, such as cocoa, strawberry powder, yoghurt powder, etc. The lipid base will typically comprise from 20-50 wt % of the coating, especially from 25-40 wt %. The lipid base of the coatings will typically include at least 5 wt % phytosterols and/or phytostanols, especially at least 10 wt % phytosterols and/or phytostanols, more preferably at least 15 wt % phytosterols and/or phytostanols.

### BACKGROUND OF THE INVENTION

Numerous activities compete for the consumer's scarce time. Work, school, continuing education, family events, children's extracurricular endeavors, leisure activities, fitness undertakings and community volunteer work are only a few. As a result, it is sometimes difficult to find the time to enjoy a full meal. Moreover, consumers often find the need to supplement traditional meals outside of customary meal times to accommodate their needs for energy to meet the demands of their challenging days.

A popular meal replacement or supplement is the nutrition bar. A nutrition bar can be used to replace a meal, particularly by those who are attempting to lose weight. In addition, nutrition bars can be a healthful source of energy between meals. Nutrition bars are typically sources of carbohydrates, protein and fats and often contain vitamins and minerals as well.

While some nutrition bars are uncoated, many consumers appreciate the presence of a coating, usually a sweet coating, on one or more sides of the bar. Among the more popular coatings is the chocolate flavored coating, which may include cocoa. Unfortunately, chocolate flavored coatings tend to be relatively high in saturated fat. Consumers appreciate other coatings as well, but these, too generally include considerable levels of saturated fat. Reports have associated excessive intake of saturated fat with elevated levels of LDL cholesterol, the so-called “bad” cholesterol. Although for many consumers any saturated fats received via nutrition bars can be expected to be a fairly limited percentage of their total intake, it may be beneficial to limit saturated fat intake where possible. The present invention seeks to provide a coating with less saturated fat.

Traska et al., U.S. Pat. No. 6,423,363 discloses aqueous dispersions of plant sterols and other high melting lipids which are said to be useful in spreads and other food products. The dispersions provide structure to the food products and their use is said to minimize or eliminate saturated fats and trans fatty acids. Food products which it is said can benefit from the inclusion of the aqueous dispersions or suspensions according to the Traska et al. invention include water continuous or no fat spreads, fat continuous spreads, bi-continuous spreads, dressings, beverages, dairy products, such as milk, cheeses and yogurt, non-dairy coffee lighteners, beverages, ice cream, and confections such as candy or chocolate. The concentration of the phytosterols or other high melting lipids in the aqueous dispersion can range from 0.1 to 99 wt %, especially from 5-75, more particularly from 10-50% Traska et al. describe oil-in water-in oil spreads which include a continuous oil phase having phytosterols or other high melting lipids, and a second oil phase dispersed in the aqueous phase.

Haynes et al. US 2004/0197446, Smith et al. US 2004/0166204, Loh et al. US 2004/0101601

Lievense, EP962150 is directed to lowering of blood cholesterol levels by regular consumption of fat based food products which comprise at least one compound of the group consisting of tocopherol and polyphenol wherein the fat comprises at least one compound of the group consisting of phytosterol, oryzanol and mixtures thereof. In the Livense application, the term phytosterol is used to cover the whole group of free phytosterols, phytosterol fatty acid esters and acylated phytosterol glucosides. Examples of food products include yellow fat spreads, dressings, coffee creamer, shortenings, cooking and frying oils, fillings and toppings and the like. The invention is said to be particularly suitable for yellow fat spreads, dressings, cheese, shortenings and cooking and frying oils.

Lievense, EP828434 is directed to fat based food products which comprise at least two of the healthy minor components, tocotrienol, oryzanol and phytosterol. The use of at least one of phytosterol and oryzanol is preferred since these components are said to show an effect on blood cholesterol even stronger than tocotrienol. The concentration of the healthy minor oil components should be high if it is desired to make a product in which the fat is replaced by non-fat ingredients, and a large amount of the other ingredients in the concentrate are fatty component. Examples of fat based food products given are yellow fat spreads, dressings, coffee creamer, cheese, shortenings, cooking and frying oils, fillings and toppings and the like. In Example IV, hamsters were fed semi-purified diets containing 30% fat as energy, 23% as protein, 47% as carbohydrates, 0.01% cholesterol, and either 0.4% phytosterol preparation, alone or in combination with 100 ppm tocotrienols or nothing. Ratio of polyunsaturated fatty acids (PUFA) to monounsaturated fatty acids (MUFA) to saturated fatty acids (SAFA) in the diet was either 7.2:12:10.8 (high PUFA) or 3:12:15 (high SAFA).

Ritter et al., U.S. Pat. No. 6,846,507 discloses an organo gel composition which is largely composed of a liquid fatty component and a mixture of sterols. The organo gel is said to have a firmness larger than that of the liquid fatty component when compared at the same temperature. The method involves replacing part or all of the solid fat in a fat composition by use of an organo gel. The organo gel is largely composed of a liquid fatty composition, at least one sterol and at least one sterol ester. Ritter et al. prefer to use solid fat having a low level of saturated fatty acids, say less than 10%, and a trans fatty acid level of less than 4%. Ritter et al. disclose that sterols and sterol esters found to be highly suitable for providing hardness to the liquid are selected from the group of phytosterols. The organo gel is referred to as a “structured” liquid fat. A highly suitable combination is said to be found in the use of oryzanol and sitosterol. It was found in the preferred embodiment that sitosterol and oryzanol provides significant and sufficient structure to a edible liquid acyl glyceride when both are present in a total amount of at least 2 wt %.

Ritter et al. point out that from a nutritional point of view it is desired that in food products “as little saturated fat (saturated fatty acid groups containing triglycerides) are present. Ritter et al. indicate that although it is very possible to prepare food products in which all fat is present in the form of an organo gel, in one embodiment the food comprises fat in the form of an organo gel and another (solid) fat. Experiments are given in Table II for hardness results in solutions containing varying amounts of oryzanol and sitosterol. Table III is said to show that the hardness of the structured sunflower oil increases substantially when increasing the total amount of the phytosterols. Ritter et al. desire that both the at least one sterol and at one sterol ester are present in an amount of at least 1 wt % each based on the total amount of liquid fat used in the organo gel. Ritter et al. in one embodiment is directed to a method to replace part or all of the solid fat in a fat composition composed of solid fat alone or of a mixture of solid and liquid fat by use of the organo gel. Ritter et al., EP918465, is from the same patent family as U.S. Pat. No. 6,846,507.

Zawistowski WO 2005/074726 is directed to a method of preserving a food product from both deterioration to microbial growth and oxidation, which comprises adding to the food product one or more phytosterols, phytostanols or mixtures thereof. Phytosterol and phytostanol as used in the '726 application includes free phytosterols and phytostanols and esterified phytosterols and phytostanols. Preferably, in order to maximize both the antimicrobial and antioxidant effects, the phytosterol component is a combination of free sterols and/or free stanols and sterol esters and/or stanol esters. When the base matrix is fat like cocoa butter, the phytosterols and/or phytostanols may be incorporated therein using microfluidizing technology and subsequently used to make chocolate and other confections. Phytosterols and/or phytostanols can be emulsified into oils and fats and then subsequently used to produce dressings such as salad and vegetable dressings,\mayonnaise, dairy and non-dairy spreads, chocolates and other confections and beverages. '726 mentions PCT/CA00/01298 which is said to describe a method of incorporating phytosterols or phytostanols into an edible oil or fat composition and in which the phytosterols or phytostanols are substantially completely dissolved, which comprises heating the phytosterols or phytostanols to form a molten material, heating the edible oil or fat, mixing the molten material with the edible oil or fat and pouring the composition. Among food products mentioned are shortenings, baked goods, sauces, fried snack products, confections and chocolate. Confectioneries mentioned include chewing gum, chocolates, candies, desserts, non-dairy toppings (for example Cool Whip™), sorbets, icings and other fillings. Among miscellaneous products are included snack foods.

Example IV of Zawistowski is directed to preparation of a chocolate confection comprising microparticulates of phytosterols and/or phytostanols. Example XII is directed to a chocolate. 6% of “Reducol” which comprises campesterol, campestanol, beta sitosterol and sitostanol was dissolved in soybean oil. The blend which comprised 20% Reducol was subsequently emulsified using a high pressure microfluidizer at 20,000 PSI. Chocolate was composed of an outer shell (“42 wt %”, no Reducol) and a center (69%, Reducol). The chocolate outer shell was made by mixing 45% sugar, 20% whole milk powder, 23% cocoa butter, 12% cocoa mass, 0.3% soy lecithin and pure vanilla (0.1 %) in a heating tank where the ingredients were melted, tempered and deposited into molds. The inner chocolate was prepared by mixing above ingredients in the same proportions as for the outer shell and melted and tempered. The Reducol/soybean oil blend was mixed with chocolate in the 1:1 ratio and deposited into molds. 10-12 chocolate pieces were produced. Example XVI is entitled Chocolate with Free Sterols/Sterol Esters. Example XVI is a milk chocolate prepared with free sterols and sterol esters. In Examples XVII, Zawistowski indicates that esters alone do not have an oil stabilizing effect.

Furcich, WO 2007/024770 is directed to methods of forming phytosterol-fortified cocoa powder and the product formed therefrom. U.S. Pat. No. 6,743,450 is cited for disclosing methods for extracting from cocoa hulls cocoa oil which is high in sterols. U.S. Application No. 2003/0068425 is cited as disclosing compositions containing steryl esters which can be incorporated into confectionery products. WO 01/78529 is cited as disclosing foods and food additives containing cocoa polyphenols (e.g., sterol or stanol based cholesterol lowering agents). '529 is said also to describe extraction of polyphenols and that sterols can be added to sugar, butter, cocoa mints or melted chocolate. Sterols can be mixed with a fat first or added to melted chocolate. WO 2004/093571 is cited as disclosing that adding sterols to cocoa beverages can mask the bitter taste. Furcich reports that sterols are found in the cocoa plant, albeit at relatively low levels and that most of the sterols found in cocoa are in the cocoa butter, at levels of about 200 PPM.

The '770 method may include grinding roasted cocoa beans, thus producing a cocoa mass, removing cocoa butter from the cocoa mass, thus producing a press cake and spraying the phytosterol in liquid form onto the press cake and grinding the press cake thus producing enriched cocoa powder. Furcich indicates that generally use of press cake with a lower fat content will allow greater amounts of phytosterols to be added. For certain embodiments of the Furcich invention it is said that it may be desirable to use press cake with a fat content that is below 20%, and for some embodiments a fat content below 16% and for other embodiments a fat content that may be 12% or lower. The sterol-fortified cocoa powder can be incorporated into food products directly or can be incorporated into flavored coatings or liquids including but not limited to syrups, coatings, molten compositions, etc. A sterol-fortified cocoa powder can also be incorporated into chocolate flavored solid compositions including but not limited to slabs, chunks, inclusions, wafers, chips, drops, flakes, etc. The cocoa powder fortified with phytosterols can be used in any food product in which unfortified cocoa powder or chocolate currently or can be used, such as chocolate flavored food products, food products enrobed in chocolate or chocolate flavored coating. It can be used in snack bars and meal bars including cold extruded bars, chocolate flavored bars and enrobed bars, bars containing chocolate, chocolate fillings or chocolate flavored pieces.

Khare U.S. Application No. 2003/0068425 discloses confectionery products comprising steryl esters wherein the ester moiety includes at least 80% oleic acid and the steryl esters can be used to replace or extend a fat such as cocoa butter. Examples mentioned include chocolate, brownies, meal replacement bars, granola bars, a syrup, a pudding, a savory sauce and the like. In example 5, a purified egg shell diet is supplemented with phytosterols and/or cocoa powder. A synergistic effect of phytosterol and cocoa powder was reported. In Example 6, a toffee chew including phytosterol, carmel and cocoa is prepared, as is a dark chocolate containing phytosterols.

Veldhuizen et al., WO 2005/074717 is directed to particulate compositions comprising a matrix material and a fatty matter wherein the fatty matter comprises 5-100% phytosterols for use as, for example, a creamer or a whitener. Veldhuizen et al. mention that in oils, phytosterols exist mainly as free sterols and sterol esters of fatty acids although sterol glucosides and acylated sterol glucosides are also present. Veldhuizen et al. prefer phytosterols selected from the group comprising fatty acid esters of beta sitosterol, beta sitostanol, campesterol, campestanol, stigmasterol, brassicasterol, brassicastanol or a mixture thereof. The Veldhuizen invention also relates to food compositions comprising the particulates such as (wet) soups and sauces and the (dry) concentrates thereof. It is said that the particulates may also be used in non-savory applications for performing a creaming and/or whitening effect such as beverages like tea, coffee, cocoa drinks, as well as compositions for preparing these. Thus, the invention further relates to a composition which may comprise tea powder, instant tea, tea flavor, cocoa powder, instant cocoa, cocoa flavor, cocoa coloring, dried cocoa, cocoa concentrate, coffee powder, instant coffee, coffee flavor, coffee coloring, dried coffee, coffee concentrate, etc. An additional benefit of the invention is said to be that it permits inclusion of phytosterols which have health benefits and allows the manufacturer the use of low calorie and low SAFA (saturated fatty acids) lighteners/creamers.

According to Veldhuizen et al., when using fatty acid ester derivatives of phytosterols or phytostanols, the ester can be prepared so that it is low in SAFA (and low in trans fatty acids) and so fatty matter so prepared can have suitable melting and other behavior to be processed into a creamer and/or lightener, and still have suitable properties upon use. The phytosterols used in Veldhuizen's invention are preferably esterified with a fatty acid and a naturally occurring fat or oil can be used as the source of the fatty acid to carry out the esterification. Fatty acid mixture may contain a higher amount (larger than 50%, preferably greater than 70%, some would prefer greater than 80%) of unsaturates, whether monounsaturated fatty acids (MUFA) and/or polyunsaturated fatty acids (PUFA). Preferably, fatty acid mixtures of sunflower, safflower, rape seed, linseed, olive oil, linola and/or soybean are used.

Chimel et al. US 2005/0069625 disclose bars and confectionaries which contain sterol esters and/or stanol esters and cocoa solids having a high cocoa procyanidin (CP) content. The high CP cocoa powders of the invention are said to be useful in the preparation of confectioneries including chocolates particularly semi-sweet and dark chocolates, cookies including brownies, cakes, chocolate coatings, toffees, caramels, hard candies, and the like. Examples of esterified sterols include sitosterol acetate, sitosterol oleate and stigmaseterol oleate.

Wester U.S. Pat. No. 6,929,816 discloses use of fatty acid esters, such as the unsaturated fatty acid esters of sterols and/or stanols, as a replacement for a substantial portion or all of the undesirable saturated fat and trans-unsaturated fats used in structure giving hardstocks in edible foods such as margarines, cooking oils and shortening.

Pischel et al. US 2003/0203854 is directed to a composition for affecting serum cholesterol levels which includes at least a waxy acid with 23 to 50 carbon atoms or derivatives and a component with serum cholesterol level affecting properties such as phystosterol. The composition can be used in a capsule, tablet, barr, beverage, oil, oil- of fat based emulsion, etc.

Tamarkin et al. US 2002/0132035 is directed to an oil or fat composition comprising a synthetic fat and oil and an edible solid agent, in particular long chain fatty acids and/or long chain fatty alcohols. In one embodiment, the composition also includes an anti-cholesteremic therapeutic agent, such as sterol or stanol, statins, omega-3 fats, and cholesterol reducing chromium and vanadium salts. Among possible applications mentioned are chocolate substitutes, ice cream coatings and cake coatings.

Mehansho et al. U.S. Pat. No. 5,707,670 mentions animal and plant sterols among a number of possible bilayer stabilizers for inclusion in an edible carrier for a nutritional iron composition. The stabilizer may be mixed with an emulsifier and then mixed with a substrate to form the carrier. Mehansho et al. mention that the emulsifier is preferably coated onto an edible substrate to form the carrier. The compositions are especially useful in food and beverage products such as chocolate flavored edible mixes such as food or beverage mixes. Among the many types of food mentioned are cereal products, puddings, dips, syrups, pie and other dessert fillings and frostings. Emulsifiers mentioned include phospholipids, glycolipids, and fatty acid monoglycerides.

Goto et al. US 2003/0124288 discloses a coating formed from a lipid solid at ordinary temperature and a water soluble additive or edible polymer. The whole surface of a core material such as a powdered flavor can be coated. The coated powder can be used to impart or enhance aroma and flavor in foods and drinks. Among the many lipids mentioned are sterols. Listed among the water soluble additive and edible polymer are monosaccharides, oligosaccharides, natural gums, starches, sugar alcohols and proteins. The core material are solid at ordinary temperature and include flavor compositions, seasonings and sweeteners.

Plank et al. US 2006/0019021 is directed to compositions containing fat and a cyclodextrin. The fat compositions with cyclodextrin are said to be harder or more viscous. Analysis for sterols is mentioned. The thickened fat can be used as an ingredient or phase of a food product. A fondant comprising the thickened fat can be used as a coating or icing for a variety of baked goods.

Valix US 2004/0076732 is directed to wax composition which includes wax esters, aldehydes, triglycerides, alcohols and free fatty acids, sterols and polar lipids. The composition can be used as a comestible base or for coating comestibles. The wt % of free fatty acid/sterol in the wax is given as 5.9-7.8.

Wester et al., U.S. Pat. No. 6,800,317 reports that stanol fatty acid esters with fatty acids based on commercially available high polyunsaturated fatty acid vegetable oils will show too high texturizing properties in vegetable oils or their blends in order to be incorporated into foods like salad oils, cooking oils, easily pourable salad dressings, sauces and mayonnaise in amounts high enough for an adequate daily intake of stanols and sterols in order to obtain an optimal cholesterol lowering effect. The '317 invention is said to be based on the finding that sterol and/or stanol fatty esters in which more than 50% of the fatty acid moieties comprises polyunsaturated fatty acids and less than 7% comprise saturated fatty acids show basically no texturizing properties. EP107591 is from the same patent family as U.S. Pat. No. 6,800,317. By using sterol and/or stanol fatty acid esters according to the '317 patent, even high amounts of phytosterols and phytostanols are said to be successfully used in vegetable oil based food products like salad oils, cooking oils, easily pourable salad dressings, sauces and mayonnaises. '317 also reports that capsules with free sterols and stanols suspended in safflower oil or mono-olean have been used as a means for lowering elevated cholesterol, although the sitostanol capsule regimen did not specifically reduce LDL cholesterol levels compared to the cholesterol lowering diet alone.

Auriou US 2003/0165572 is directed to a water dispersible powder containing one or more sterols. It is said that the dried powder can be added to water based edible or drinkable formulations to administer the cholesterol lowering sterol in conjunction with a fat restricted diet. Foods for which the sterol in powdered form is mentioned include bars, confectionaries, cereal bars, crackers, biscuits, other baked goods, chocolate and the like. Emulsifiers and emulsion stabilizers may be included. Starch is an excipient for the composition; optional excipients include dextrose, fructose, sucrose and lactose.

Hallstrom et al. U.S. Pat. No. 4,160,850 discloses use of phytsterols as emulsifiers in mixes for spreads which can be prepared in the home.

Other related art include Sato et al., U.S. Pat. No. 5,186,866, Nakhasi et al., U.S. Patent Publication No. US2005/0196512, Wester et al., U.S. Pat. No. 6,827,964, Wester et al., EP 1225811, EP107591, Coeenewerck, WO 2006/005141, Lin, WO 2007/039040, van Amerongen et al., U.S. Pat. No. 6,106,886, Grigg et al US 2008/0089978, Basheer et al. US 2004/0105931, Vulfson et al WO 00/41491, and Dilley, WO 2006/066979.

### SUMMARY OF THE INVENTION

The invention is directed to a fat continuous coating which is suitable for coating nutrition bars and other products, especially foods products, which include less saturated fat.

The coating of the invention is a fat-continuous coating including a lipid base including a phytosterol and/or phytostanol structurant, and up to 28 wt % or less saturated fatty acid moieties. The phytosterol is not present in an aqueous dispersion but is present in the continuous fat phase of the coating. Preferably the coating has a moisture content of 1 wt % or less. The phytosterol or phytostanol serves to provide sufficient structure to the coating to obviate the need for the higher levels of saturated fats which such ingredients tend ordinarily to contain.

The lipid base will typically comprise from 20-50 wt % of the coating, especially from 25-40 wt %.

Preferably, the lipid base of the coatings include at least 5 wt % phytosterols and/or phytostanols, especially at least 10 wt % phytosterols and/or phytostanols, more preferably at least 15 wt % phytosterols and/or phytostanols.

In accordance with a preferred embodiment, the lipid base will include, in addition to the phytosterol or phytostanol, substantial levels of polyunsaturated fatty acids and/or monounsaturated fatty acids. Polyunsaturated fatty acids have been reported to have salutary effects on cholesterol levels, and monounsaturated fatty acids are reported at least to be neutral with respect to cholesterol levels. Preferably, the lipid base of the invention include at least 5 wt % combined levels of polyunsaturated fatty acids and monounsaturated fatty acids and more preferably at least 2 wt % of polyunsaturated fatty acids and/or at least 2 wt % monounsaturated fatty acids. The lipid blend preferably includes at least 10 wt % combined levels of polyunsaturated fatty acids and monounsaturated fatty acids and more preferably at least 4 wt % of polyunsaturated fatty acids and/or at least 4 wt % monounsaturated fatty acids.

The coating will advantageously include numerous other ingredients typically found in coatings, such as cocoa, strawberry powder, yoghurt powder, etc.

It may be useful for the coatings to be within the following ranges of ingredients and parameters:
Range of Total Sugars −75% or less, preferably 5-75%, especially 35-50%
Range of Water −0-3%, especially 1% or less
Range of Total Fat −10-65%, especially 30-50%
Range of Saturated Fat −0.5-60%, especially 25-45%

Preferably, its viscosity may be within the range of Range from 10-25 mPas.

In a preferred lipid base, the triglyceride component is a mixture of hydrogenated palm kernel oil and either sunflower oil or olive oil in a weight ratio of (hydrogenated fat to high MUFA oil) of from 2:1 to 10: 1, preferably from 3:1 to 8:1. Preferably the palm kernel oil is fully hydrogenated. Preferably the lipid base comprises at least 50 wt % palm kernel oil and at least 5 wt % olive oil and or sunflower oil. More preferably, the lipid base comprises at least 60 wt % palm kernel oil and at least 10 wt % olive oil and or sunflower oil.

For a more complete understanding of the above and other features and advantages of the invention, reference should be made to the following detailed description of preferred embodiments and to the accompanying drawings.

### DETAILED DESCRIPTION OF THE INVENTION

The coating of the invention will typically comprise a lipid base, an ingredient which gives the coating its characteristic flavor, such as cocoa or strawberry powder, a sweetener such as a sugar and sugar alcohol, and various optional ingredients such as milk solids, acidulant, and flavors. The coating is fat continuous and preferably substantially moisture free. Preferably the coating according has a moisture content of less than 0.75 wt %, especially less than 0.5 wt %.

The lipid base will typically include phytosterol and/or phytostanol, and triacylglycerol fat. Preferably, the triacylglycerol fat will include a source of poly- and/or mono-unsaturated fatty acids such as a vegetable oil, and, if required, a source of saturated fatty acids. The lipid base will typically be 5 to 30 wt % phytosterol and/or phytostanol, and 70 to 95 wt % triglyceride source such as oil or fat.

The present invention utilizes phytosterols and/or phytostanols rather than the phytosterols and phytostanols which have been esterified, such as the phytosterols esterified with fatty acids which have been disclosed for many previous food applications. As used in the discussion of the invention in the present application, “phytosterols,” “phytostanols” and specifically named phytosterols and phytostanols refer to molecules which have not been esterified, unless otherwise stated. It should be noted that in the patent and other literature, such as the background art discussed above, authors do not always take care to distinguish between the sterols and their esters.

The molar ratio of phytosterols and phytostanols to any phytosterol esters and phytostanol esters in the compositions of the invention is preferably greater than 10:1. The coating preferably includes less than 1 wt % phytosterol ester and phytostanol ester, especially than 0.8 wt % phytosterol ester and phytostanol ester, more preferably less than 0.5 wt % phytosterol and phytostanol ester. Most preferably, the phytosterols and/or phytostanols used in the invention, and the coatings, are essentially free of phytosterols and phytostanols esterified to fatty and other carboxylic acids. The coating is also preferably essentially free of oryzanol.

The sterols and stanols used in the present invention are those which are available from plants. Sterols can be classified in three groups, 4-desmethylsterols, 4-monomethylsterols, and 4, 4′-dimethylsterols. In oils they mainly exist as free sterols and sterol esters of fatty acids although sterol glucosides and acylated sterol glycosides are also present. There are three major phytosterols, namely, beta-sitsterol, stigmasterol and campesterol. The phytostanols are the respective 5 alpha-saturated derivatives of phytosterols such as sitostanol, campestanol and their derivatives. Synthetic analogues of any of the phytsterols or phytostanols (which include chemically modified natural components) may also be used except that fatty acid esters are to be excluded or limited as elsewhere described herein.

Among sources for the unsaturated acids which are included in the lipid base in accordance with the invention, may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

Among the polyunsaturated fatty acids which may be included in the triacylglycerides of the lipid base are arachidonic acid, docosahexaenoic acid (DHA), eicosapentaenoic acid (EPA), lineoleic acid, linolenic acid (alpha linolenic acid), gamma-linolenic acid, and conjugated linoleic acid (CLA). The most common monounsaturated fatty acid which will be included in the triglycerides of the lipid base will be oleic acid. The level of each of these in the triglycerides of the lipid base may independently be at least 0.5 wt %, especially at least I wt %.

Any saturated fatty acids in the lipid base will preferably be supplied by fats which have not been hydrogenated or which have been fully hydrogenated, to avoid inclusion of trans fatty acids. Fats which have not been hydrogenated will include fats which already have satisfactory levels of saturated fatty acids or fats which have been interesterified to increase their levels of saturated fatty acids. Examples of suitable fats which have been fully hydrogenated include hydrogenated palm oil and hydrogenated palm kernel oil.

In accordance with the invention, the fat-continuous coating has less than 28 wt % saturated fat, particularly from 5 wt % up to less than 28 wt % saturated fat, especially less than 25 wt % saturated fat, preferably less than 20 wt % saturated fat.

Flavoring ingredients in the coating of the invention may include cocoa, strawberry powder, yoghurt powders, flavored and unflavored. If desired the cocoa may be included in the form of cocoa mass, cocoa butter, cocoa powder or chocolate. The flavoring preferably comprises from 25-75 wt % of the coating, preferably from 25 to 50 wt % of the coating. GENKEN cocoa is a preferred flavoring.

The coating will typically include from 0 to 50 wt %, especially 1 to 30wt %, natural sweeteners. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Sugar sweeteners are preferably used at from 0 to 50 wt %, especially 1 to 30 wt %. Sugar alcohols are typically used at from 0 to 20 wt %, especially from 1 to 10 wt %.

If it is desired to use artificial sweeteners in the coating, any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are used in varying amounts of about 0.0001% to 1 wt % on the coating, preferably 0.01 to 0.5 wt % depending on the sweetener, for example.

The coating of the invention may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. If desired to minimize the caloric impact, protein may be added as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the coatings of the invention are preferably within the range of 0 wt % to 20 wt %, such as from 0.5 wt % to 15 wt %.

Where a cocoa-containing coating is needed, it may be desirable to include little or no milk or milk ingredient so as to maximize the reported beneficial effects of chocolate antioxidants and, if and to the extent desired, to try to avoid reported neutralization of antioxidants in the chocolate by milk or its components such as casein.

The coating may include acidulants such as malic and citric acids at levels of from 0.05 to 1 wt %, especially 0.1 to 0.5 wt %.

As used in this application, a “liquid fat” means a fat which is pourable at the temperature at which its application is envisaged. For most products and in the preferred embodiments this will mean room temperature (20° C.).

The coating of the invention can be used to coat nutrition bars and other products. Nutrition bars and methods of making are described in Gautam et al. US Published Patent Application No. 2006/0115553, the disclosure of which is hereby incorporated by reference in its entirety. Bars can be prepared by cooking a syrup containing liquid ingredients, and then mixing dry ingredients. The mixture is then extruded onto a conveyor belt and cut with a cutter. Or bars may be formed by cooking the syrup, adding dry ingredients, blending the syrup and dry ingredients in a blender, feeding the blended mix through rollers and cutting with a cutter. The cut bars may be coated or enrobed in the coating and then it may be cooled in a cooling tunnel to set the coating.

Nutrition bars generally include protein, carbohydrate, fat and often include vitamins and minerals as well. For instance, carbohydrates in the body of the bar (excluding the coating) may be present at from 0 to 90 wt %, especially from 1 to 49 wt %. Fats in the body of the bar may for example be present at from 0 to 45 wt %, especially up to 35%, more preferably from 0.5 to 10 wt % and still more preferably from 0.5 to 5 wt %. Proteins in the body of the bar may for example range from 3 wt % to 50 wt %, preferably from 3 to 30 wt %, especially from 3 to 20 wt %.

As used in this specification, “essentially free” means having less than 0.05 wt % of the indicated ingredient.

The amount of saturated fatty acid (SAFA) in a fat or a blend of fats in an overall composition is a percentage (by weight) of saturated fatty acids, i.e., fatty acids which have no carbon-carbon double bonds.

### EXAMPLE 1

Lipid Base Preparation

Sample

| Ingredient | #A | #B |
|---|---|---|
| Palm oil Kernel, Hydrogenated | 60 | 40 |
| Cargill Corowise ™ PS100 | 20 | 20 |
| Sunflower oil | 20 | 40 |

Sample

| Ingredient | #C | #D | #E | #F |
|---|---|---|---|---|
| Palm oil Kernel, Hydrogenated | 80 | 60 | 40 | 60 |
| Cargill Corowise ™ FP300 | 10 | 20 | 20 | 10 |
| Olive oil, pure | 10 | 20 | 40 | 30 |

Sample

| Ingredient | #G | #H | #I |
|---|---|---|---|
| Palm oil Kernel, Hydrogenated | 50 | 65.65 | 50 |
| Cargill Corowise ™ FP300 | 10 | 11.83 | 5 |
| Corn-oil Spread Eger ™-IVB | 40 | 22.51 | 45 |

The Palm oil kernel was melted at 85° C. The phytosterols were added and dissolved. Then the oil was added, stirred, and let cool down to room temperature.

Coating Preparation

| | Sample | | | | | | | | | |
|---|---|---|---|---|---|---|---|---|---|---|
| Ingredient | # A | # B | #C | #D | #E | #F | #118C | #149S | #151S | #152S |
| Lipid Base | 38.39 | 38.39 | 38.39 | 38.39 | 38.39 | 38.39 | 28.85 | 28.85 | 28.85 | 28.85 |
| 10/12 Black Pearl | | | 30 | | | | | | | |
| Cocoa Powder, | | | | | | | | | | |
| Barry Callebaut | | | | | | | | | | |
| 10/12 Amber | | | | 30 | | | | | | |
| Genken Cacao, | | | | | | | | | | |
| Cargill | | | | | | | | | | |
| 10/12 Sienna | | | | | 30 | | | | | |
| Genken Cacao, | | | | | | | | | | |
| Cargill | | | | | | | | | | |
| 10/12 Russet Plus | | | | | | 30 | | | | |
| Genken Cacao, | | | | | | | | | | |
| Cargill | | | | | | | | | | |
| Firmenich | | | | | | | | 0.33 | 0.33 | 0.33 |
| Strawberry Flavor | | | | | | | | | | |
| 75890702811A | | | | | | | | | | |
| Sucrose | | | 20 | 20 | 20 | 20 | | 7.64 | 7.64 | 7.64 |
| Milk solids | | | 11.61 | 11.61 | 11.61 | 11.61 | | | | |
| Citric Acid | | | | | | | | 0.3 | 0.3 | 0.3 |
| Sucralose | | | | | | | | 0.34 | 0.34 | 0.34 |
| Erythritol | | | | | | | | 2.5 | 2.5 | 2.5 |
| Freeze dried | | | | | | | | 67.68 | 67.68 | 67.68 |
| Strawberry Powder, | | | | | | | | | | |
| Van Drunen Farms | | | | | | | | | | |
| Hi Protein Chocolate | 61.61 | 61.61 | | | | | 61.61 | | | |
| 101871 Kerry | | | | | | | | | | |
| Ingredients | | | | | | | | | | |
| Texture RT (25° C.) | Hard | Hard | Hard | Hard | Hard | Hard | Hard | Hard | Hard | Hard |
| Melts in mouth | Yes | Yes | Yes | Yes | Yes | Yes | Yes | Yes | Yes | Yes |
| % Saturated Fat | 23.03 | 15.36 | 30.74 | 23.03 | 15.36 | 15.36 | 17.3 | 27.36 | 18.91 | 17.67 |

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A fat-continuous coating comprising:
a) a lipid base including a phytosterol and/or phytostanol structurant,
b) said coating having a moisture content of less than 1 wt %.
c) said coating having 28 wt % or less saturated fatty acid moieties said phytosterol and/or phytostanol providing structure to the coating.

2. The fat-continuous coating according to claim 1 having a moisture content of less than 0.75 wt %.

3. The fat-continuous coating according to claim 3 having a moisture content of less than 0.5 wt %.

4. The fat-continuous coating according to claim 2 wherein said lipid base includes triglyceride fat.

5. The fat-continuous coating according to claim 2 further comprising cocoa.

6. The fat-continuous coating according to claim 2 further comprising strawberry powder.

7. The fat-continuous coating according to claim 6 wherein said cocoa is in the form of chocolate.

8. The fat-continuous coating according to claim 2 further wherein said cocoa comprises from 25-75 wt % of said coating.

9. The fat-continuous coating according to claim 2 wherein said lipid base comprises from 25 to 50 wt % of said coating.

10. The fat-continuous coating according to claim 2 wherein said lipid base includes from 5 to 30 wt % of said phytosterol and/or phytostanol.

11. The fat-continuous coating according to claim 1 further having less than 25 wt % saturated fat.

12. The fat-continuous coating according to claim 1 further having less than 20 wt % saturated fat.

13. The fat-continuous coating according to claim 1 further having from 5 wt % up to less than 28 wt % saturated fat.

14. The coating according to claim 1 wherein any liquid fat is essentially free of phytosterol- and phytostanol-esters.

15. The coating according to claim 1 wherein any liquid fat includes less than 1 wt % phytosterol- and phytostanol-ester.

16. The coating according to claim 15 wherein any liquid fat includes less than 0.8 wt % phytosterol and phytostanol ester.

17. The coating according to claim 16 wherein any liquid fat includes less than 0.5 wt % phytosterol and phytostanol ester.

18. The coating according to claim 1 essentially free of oryzanol.

19. The coating according to claim 1 wherein the molar ratio of phytosterols to phytosterol esters is greater than 10:1.

20. A fat-continuous coating comprising:
a. a lipid base including a phytosterol and/or phytostanol structurant,
b. said coating having a moisture content of less than 1 wt %.
c. said coating having 28 wt % or less saturated fatty acid moieties said phytosterol and/or phytostanol providing structure to the coating,
d. said coating being essentially free of phytosterol and phytostanol esters,
e. said coating including at least 0.5 wt % monounsaturated fatty acid moieties, and
f. said coating including at least 0.5 wt % polyunsaturated fatty acid moieties.

21. The coating according to claim 20 comprising hydrogenated palm kernel oil and an oil selected from the group of olive oil, sunflower oil and mixtures thereof.

22. The coating according to claim 22 comprising from 40-90 wt % hydrogenated palm kernel oil and at least 5 wt % of olive and/or sunflower oil.
